(19) United States
(12) Patent Application Publication
(10) Pub. No.: US 2026/0330364 A1
(43) Pub. Date: Oct. 22, 2026

(54) Cognition-Compatible Semantic Agent Objects with Structural Validation, Partial Agent Support, and Traceable Semantic Lineage

(71) Applicant: Nicholas Clark, Thetford Center, VT (US)

(72) Inventor: Nicholas Clark, Thetford Center, VT (US)

(21) Appl. No.: 19/452,651

(22) Filed: Jan. 19, 2026

Related U.S. Application Data
(60) Provisional application No. 63/789,967, filed on Apr. 16, 2025.
(60) Provisional application No. 63/800,515, filed on May 6, 2025.

(51) Int. Cl. G06Q 10/0631

(52) U.S. Cl. CPC G06Q 10/06316

(57) ABSTRACT

Systems and methods are disclosed for defining cognition-compatible semantic agent objects structured to support memory-bearing, policy-governed, and traceable semantic execution. Each semantic agent object comprises one or more canonical semantic fields including an intent field, a context block, a memory field, a policy reference field, a mutation descriptor field, and a lineage field. Structural validation is performed at the data-object level based on field presence and coherence, independent of any particular execution environment. Partial semantic agents comprising subsets of canonical fields are supported through deterministic fallback inference and structural scaffolding. Authorized mutation pathways are governed jointly by mutation descriptors and policies identified by the policy reference field, while lineage fields preserve provenance and continuity across agent evolution. Semantic agent objects are serializable and operable across stateless and distributed computing environments, enabling decentralized semantic execution, governance enforcement, and auditability without reliance on centralized orchestration or persistent runtime state.

### RELATED APPLICATION DATA

This application claims the benefit of priority of U.S. Provisional Patent Applications Ser. No. 63/789,967, filed on Apr. 16, 2025, titled “Cross-Domain Applications of the Adaptive Query Framework” and Application Ser. No. 63/800,515, filed on May 6, 2025, titled “Cognition-Native Semantic Execution Platform for Distributed, Stateful, and Ethically-Constrained Agent Systems”, each of which is incorporated by reference herein in its entirety.

### FIELD

The present disclosure generally relates to distributed computing systems and semantic execution architectures for artificial intelligence and autonomous software agents. In particular, the present disclosure is directed to cognition-compatible semantic agent objects with structural validation, partial agent support, and traceable semantic lineage, and methods thereof.

### BACKGROUND

Distributed computing systems and artificial intelligence architectures increasingly rely on software agents to perform reasoning, coordination, and task execution across heterogeneous environments. In many existing systems, agents are implemented as runtime processes, sessions, or control loops that operate over external data stores, message queues, or orchestration frameworks. Such approaches treat agent behavior as procedural execution.

In conventional agent-based systems, semantic intent, memory, trust context, and governance constraints are typically maintained outside the agent representation, often in application logic, workflow engines, or session-scoped state. As a result, agent identity and behavior are tightly coupled to specific execution environments, making it difficult to preserve semantic continuity when agents are paused, transferred, rehydrated, or executed across stateless or federated systems.

Some systems attempt to simulate persistence by attaching memory or metadata to agent payloads; however, in such systems, partial or degraded agent representations are often invalid or require ad hoc repair logic, leading to fragility, inconsistent behavior, and limited interoperability across distributed or asynchronous environments.

Additionally, in existing agent frameworks, semantic integrity, auditability, and trust verification depend on external orchestration and centralized coordination, which do not scale well across decentralized systems.

Accordingly, there is a need for systems and methods that address these shortcomings.

### SUMMARY OF THE DISCLOSURE

A cognition-compatible semantic agent object system includes a semantic agent object stored in a non-transitory computer-readable medium, the semantic agent object comprising one or more embedded canonical semantic fields selected from the group consisting of an intent field, a context block, a memory field, a policy reference field, a mutation descriptor field, and a lineage field, and a node configured to interact with the semantic agent object and including a set of instructions that when executed determine whether the semantic agent object is structurally coherent based on presence of the one or more canonical semantic fields and whether the one or more canonical semantic fields, to the extent present, are structurally compatible based on a set of rules that determine whether those fields are permitted to coexist. Whether the semantic agent object is structurally coherent and whether the one or more canonical semantic fields are structurally compatible are determined based only on information embedded within the semantic agent object.

In another aspect, a computer implemented method for validating cognition-compatible semantic agent objects includes determining whether a semantic agent object is structurally valid based on presence and coherence of one or more canonical semantic fields embedded within the semantic agent object, determining mutation eligibility of the semantic agent object using a policy reference field in the semantic agent object and a mutation descriptor field in the semantic agent object, and recording validation or mutation outcomes within a memory field of the semantic agent object. The method is performed without prescribing execution order, scheduling, or runtime control.

### BRIEF DESCRIPTION OF THE DRAWINGS

For the purpose of illustrating the disclosure, the drawings show aspects of one or more embodiments of the disclosure. However, it should be understood that the present disclosure is not limited to the precise arrangements and instrumentalities shown in the drawings, wherein:

FIG. 1 illustrates an internal structure of a full semantic agent object in accordance with an embodiment of the present disclosure;

FIG. 2 illustrates a mutation pathway between semantic agent objects in accordance with an embodiment of the present disclosure;

FIG. 3 illustrates valid configurations of partial semantic agent objects containing subsets of the canonical fields in accordance with an embodiment of the present disclosure;

FIG. 4 illustrates interoperability between full and partial semantic agent objects in accordance with an embodiment of the present disclosure;

FIGS. 5A-5B illustrate a resolution scenario through structural scaffolding in accordance with an embodiment of the present disclosure; and

FIG. 6 illustrates a technique for construction of a traceable semantic lineage graph across multiple semantic agent objects.

### DETAILED DESCRIPTION

### 1. Introduction to the Cognition-Compatible Agent Schema

A cognition-compatible agent schema described herein is designed to structurally define memory-bearing semantic agent objects capable of traceable, policy-constrained behavior across decentralized systems. Unlike conventional message objects, ephemeral execution payloads, or session-bound control structures, each agent instantiated under the disclosed schema embeds semantic goal expression, trust context, behavioral memory, policy references, mutation descriptors, and lineage continuity within its own internal structure. This structural composition enables semantic admissibility, governed evaluation, and interoperable reasoning, independent of any particular execution process.

The cognition-compatible agent schema defines a canonical structural model in which semantic agency is represented as a first-class data object rather than as a transient runtime process. Agents instantiated under the schema are structurally self-describing and carry sufficient internal information to be validated, interpreted, and governed by receiving nodes based solely on their internal composition. This object-centric approach allows semantic agents to persist across asynchronous environments, heterogeneous execution contexts, and federated trust domains while preserving continuity of identity, governance, and provenance.

The agent schema specifies six canonical semantic fields: intent, context, memory, policy, mutation, and lineage. These fields collectively encode the semantic identity, operational constraints, and evolutionary traceability of an agent. A full semantic agent object comprises all six canonical fields and supports complete semantic autonomy within the bounds of applicable governance rules. Partial semantic agent objects, comprising subsets of the canonical fields, remain structurally valid under the schema and operate through fallback scaffolding, delegation, and inference mechanisms defined herein. The schema ensures that even minimally instantiated agent objects may participate in semantic networks and lineage graphs without requiring centralized coordination or external state reconstruction.

The cognition-compatible agent schema disclosed herein may operate within and extend a broader paradigm of cognition-native computing, such as is disclosed in U.S. Nonprovisional application Ser. No. 19/230,933, titled “Cognition-Native Semantic Execution Platform for Distributed, Stateful, and Ethically-Constrained Agent Systems,” filed Jun. 6, 2025, the entirety of which is hereby incorporated by reference. In cognition-native computing systems, semantic reasoning, memory continuity, governance constraints, and identity are treated as primary architectural substrates rather than as emergent properties of procedural execution, application logic, or runtime orchestration. The present disclosure adopts this paradigm by defining semantic agency as a structurally persistent data-object abstraction that carries its own cognitive state, policy anchors, and evolutionary history across system boundaries. In this manner, the disclosed agent schema functions as a cognition-native substrate layer that interoperates with distributed trust, identity, and policy mechanisms described in the incorporated platform disclosure, while remaining independently applicable to any system requiring persistent, auditable semantic execution. However, semantic agent objects and partial semantic agent objects may operate independently of a cognition-native semantic execution platform and are not dependent on the presence of other cognition-compatible components in order to maintain structural validity or operational viability.

By embedding memory, policy, and mutation logic at the structural level, the cognition-compatible agent schema enables agents to reason, adapt, and refine themselves across distributed and asynchronous systems. Nodes interacting with agent objects perform structural validation based on the presence, coherence, and compatibility of available canonical fields, rather than relying on procedural assumptions, execution history, or shared session state. This validation model supports deterministic governance enforcement and semantic continuity across system boundaries.

### 2. The Six Canonical Semantic Fields

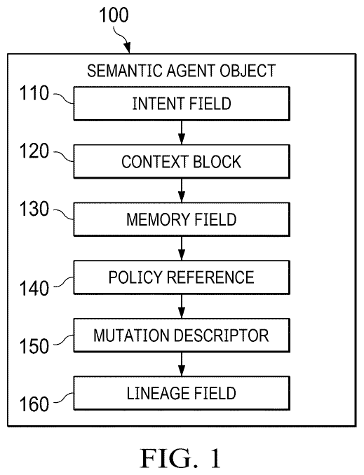

Referring now to FIG. 1, the present disclosure introduces a cognition-compatible agent schema that defines a semantic agent object as a structurally self-validating data object rather than as a runtime process, execution session, or procedural control loop. The schema enables memory-bearing, policy-governed, and traceable semantic agents to operate across decentralized, stateless, or heterogeneous computing environments without reliance on external orchestration logic or persistent execution contexts. Structural validation under the schema is performed prior to any semantic execution, mutation, delegation, or propagation, such that eligibility for semantic participation is a consequence of structural coherence rather than as a result of runtime execution.

As illustrated in FIG. 1, a semantic agent object 100 comprises a structured composition of canonical semantic fields that collectively encode the agent's identity, constraints, and evolutionary continuity. Each field is embedded directly within the agent object 100 and is individually addressable, machine-readable, and subject to structural validation under the cognition-compatible schema disclosed herein. Arrows shown between fields in FIG. 1 indicate logical relationships and dependency associations among semantic components and do not represent procedural execution order, temporal sequencing, control flow, or instruction execution.

The intent field 110 encodes a semantic objective, goal, or purpose associated with the semantic agent object 100. The intent field 110 anchors the semantic identity of the agent and provides a reference point for evaluating permissible behavior, mutation eligibility, and alignment with governing policies. The intent field 110 may specify a desired outcome, informational target, or inferential direction without prescribing execution steps or operational procedures.

The context block 120 records environmental, trust, identity, or domain-specific metadata associated with the semantic agent object 100. Context metadata may include origin identifiers, trust scope indicators, role classifications, environmental parameters, or deployment constraints relevant to interpretation of policy applicability and mutation eligibility. The context block 120 enables nodes interacting with the agent object 100 to evaluate semantic behavior relative to localized conditions without requiring centralized coordination or shared session state.

The memory field 130 retains trace outcomes associated with the semantic agent object 100, including prior evaluations, mutation events, delegation records, scaffolding resolutions, and validation results. Unlike external logging systems or session-based memory stores, the memory field 130 is embedded within the agent object itself, allowing semantic history and reasoning context to propagate with the agent across heterogeneous environments. Memory entries are appended in a traceable manner to preserve auditability and semantic continuity over time.

The policy reference field 140 identifies one or more governing policies that define constraints on permissible behavior, mutation pathways, delegation authority, semantic scope, or trust thresholds applicable to the semantic agent object 100. Policies identified by the policy reference field may point to internal policy objects, external policy identifiers, or decentralized aliasing mechanisms, provided that such references are resolvable and verifiable at validation time. The policy reference field 140 enables distributed enforcement of governance rules without reliance on centralized authorities or monolithic control systems.

The mutation descriptor field 150 defines authorized transformation pathways for the semantic agent object 100. Mutation descriptors specify conditions, triggers, or constraints under which the agent's semantic identity, intent, or structural composition may evolve. The mutation descriptor field 150 operates in conjunction with the policy reference field 140 and the context block 120 to ensure that semantic evolution occurs only within permitted bounds defined by governance rules and environmental conditions.

The lineage field 160 references one or more semantic ancestors of the semantic agent object 100, forming a traceable graph of semantic inheritance and evolution. The lineage field 160 preserves continuity of semantic identity across agent generations and supports verification of provenance, role inheritance, policy lineage, and trust relationships within distributed cognition networks.

Together, the intent field 110, context block 120, memory field 130, policy reference field 140, mutation descriptor field 150, and lineage field 160 form a canonical structural schema for cognition-compatible semantic agents. A full semantic agent comprises all six canonical fields, while partial semantic agents may comprise a subset of fields and remain structurally valid through fallback inference, delegation, and scaffolding mechanisms described in subsequent sections.

By embedding semantic identity, memory continuity, governance constraints, mutation logic, and lineage tracking directly within the semantic agent object 100, the schema disclosed herein enables decentralized systems to reason about agent behavior through structural validation at the data-object level, rather than through procedural execution analysis or external orchestration. This foundational structure supports subsequent rules for partial agent validation, structural scaffolding, interoperability, mutation governance, and lineage integrity described herein.

### 3. Schema-Based Validation of Full and Partial Semantic Agents

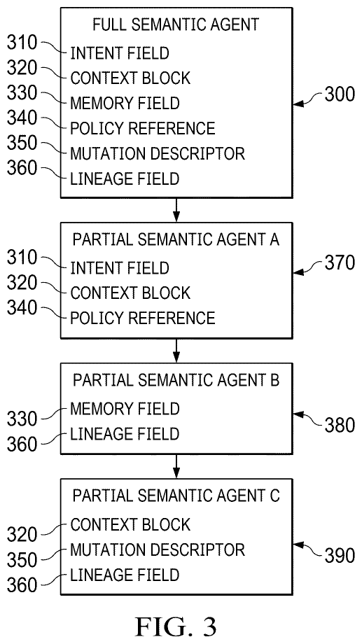

Referring now to FIG. 3, the cognition-compatible agent schema disclosed herein establishes formal structural validation rules for determining whether a semantic agent object is compliant for participation in distributed semantic systems. Validation is performed at the data-object level based on the presence, coherence, and compatibility of canonical semantic fields, rather than on runtime behavior, execution history, or procedural control flow.

As illustrated in FIG. 3, a full semantic agent 300 comprises all six canonical semantic fields, including an intent field 310, a context block 320, a memory field 330, a policy reference field 340, a mutation descriptor field 350, and a lineage field 360. A full semantic agent is validated through direct confirmation of field presence and through evaluation of logical coherence among the fields, including alignment between intent and policy, consistency between memory traces and mutation descriptors, and continuity of lineage references.

The schema further defines partial semantic agents as structurally valid agent objects that include fewer than all six canonical fields, provided that minimum field presence and coherence thresholds are satisfied. In the embodiment shown in FIG. 3, partial semantic agent A 370 includes an intent field 310, a context block 320, and a policy reference field 340. This configuration provides sufficient semantic grounding to express a governed objective within an environmental trust scope, despite the absence of explicit memory, mutation, or lineage fields.

Partial semantic agent B 380, also shown in FIG. 3, includes a memory field 330 and a lineage field 360 without an explicit intent field, context block, policy reference, or mutation descriptor. Such an agent object remains structurally valid as a reflective or audit-oriented agent capable of preserving semantic history and provenance, even though it does not initiate semantic objectives or transformations independently.

Partial semantic agent C 390 comprises a context block 320, a mutation descriptor field 350, and a lineage field 360. This configuration supports agents that participate in controlled semantic transformation or delegation under inherited trust and provenance constraints, while deferring explicit intent resolution or memory accumulation to upstream agents or scaffolded inference mechanisms.

Structural validation begins by confirming that a semantic agent object contains at least two canonical fields selected from the group consisting of intent, context, memory, policy, mutation, and lineage. This minimum threshold ensures that the agent object possesses sufficient semantic structure to support deterministic interpretation and governance. Upon satisfying the minimum threshold, validation proceeds by evaluating the logical compatibility of available fields, including consistency between policies identified by the policy reference field and mutation descriptors, alignment between memory traces and lineage anchors, and coherence between intent declarations and contextual constraints.

Where one or more canonical fields are absent, the schema permits validation through fallback inference, delegation, or scaffolding mechanisms, as described in subsequent sections. The absence of a field does not, by itself, invalidate the agent object, provided that remaining fields can support coherent semantic interpretation and that inferred or default behaviors are permitted under applicable governance rules.

Agent objects that fail minimum field presence thresholds or that exhibit irreconcilable conflicts among available fields are deemed structurally non-compliant. Such objects may be rejected, quarantined, or subjected to scaffolding repair procedures according to environmental policy and validation rules. Validation outcomes are deterministic and reproducible, enabling decentralized enforcement of schema integrity across heterogeneous systems without reliance on centralized validators or synchronized state.

FIG. 3 illustrates representative configurations of full and partial semantic agents that remain structurally valid under the cognition-compatible schema. The validation model described in this section enables distributed semantic systems to accept, reason about, and govern agent objects based solely on their internal structure, supporting scalable interoperability, fault tolerance, and semantic continuity across distributed and stateless environments.

### 4. Partial Agents and Structural Incompleteness

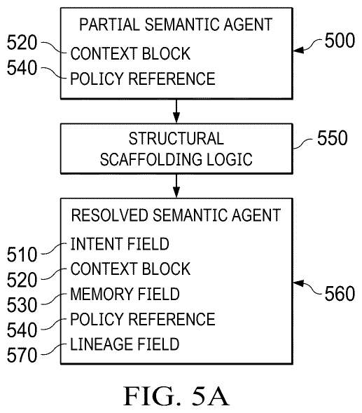

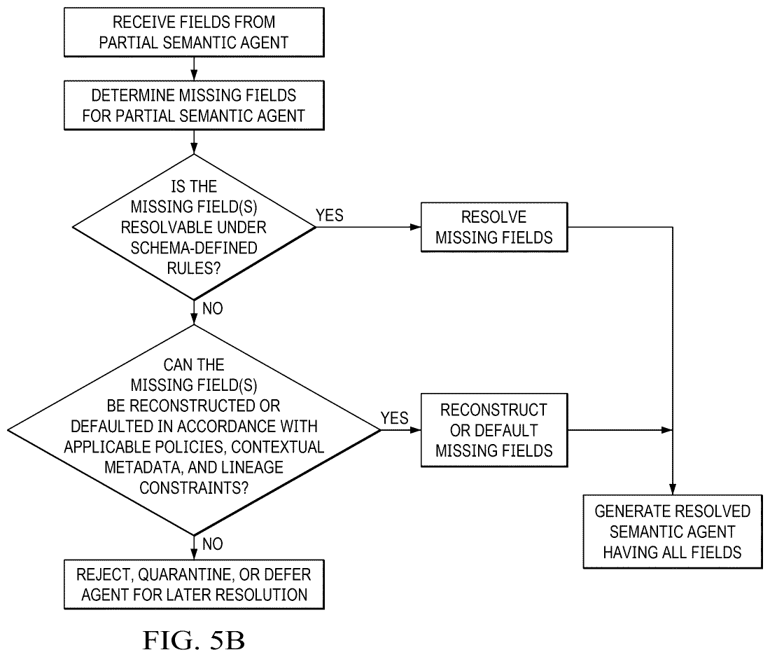

Referring now to FIG. 5, the cognition-compatible agent schema accommodates the existence and operation of partial semantic agents, which are semantic agent objects containing fewer than all six canonical fields but remaining structurally valid through fallback inference, delegation, or environmental scaffolding. Partial agents enable semantic continuity, mutation propagation, and distributed coordination in asynchronous, resource-constrained, or stateless environments without requiring full-field instantiation at every lifecycle stage.

As illustrated in FIG. 5A, one embodiment of a partial semantic agent 500 comprises a subset of canonical fields including a context block 520 and a policy reference field 540 while lacking one or more additional fields such as an explicit intent field, memory field, mutation descriptor, or lineage field. The partial semantic agent 500 is not considered invalid by virtue of incompleteness alone. Instead, the schema evaluates whether the available fields provide sufficient semantic structure to support deterministic interpretation and governed participation within the environment.

Structural incompleteness is addressed through structural scaffolding logic 550, which operates as a schema-defined resolution mechanism rather than as procedural execution logic. Structural scaffolding logic 550 evaluates the fields present in the partial semantic agent 500 and determines whether missing canonical fields may be resolved under schema-defined rules, reconstructed, or defaulted in accordance with applicable policies, contextual metadata, and lineage constraints. The scaffolding logic 550 may be implemented locally by a validating node, federated system, or trusted peer, provided that resolution outcomes are recorded within the agent object itself.

In FIG. 5B, the illustrated stages represent logical structural evaluation conditions applied to a partial semantic agent object (but do not necessarily prescribe execution order, scheduling, control flow, or runtime behavior). The process depicted reflects a schema-governed assessment in which fields present in the partial semantic agent are inspected to identify missing canonical semantic fields, and a determination is made as to whether such missing fields are resolvable under schema-defined structural rules. Where missing fields are resolvable, the determination includes whether such fields may be reconstructed, inferred, or defaulted in accordance with applicable policy references, contextual metadata, and lineage constraints, including inheritance or anchoring to a prior semantic state. In one embodiment, such resolution results in a resolved semantic agent representation that includes representations corresponding to all canonical semantic fields, which may include defaulted, inferred, proxy, or scaffolded field values rather than semantically complete or executed state. Where missing fields are not resolvable under the applicable schema-defined rules or policy constraints, the semantic agent object may be structurally rejected, quarantined, or deferred for later resolution, such outcomes reflecting structural inadmissibility or unresolved schema constraints rather than semantic error, execution failure, or behavioral evaluation.

In the embodiment shown in FIGS. 5A-5B, structural scaffolding logic 550 resolves missing semantic components to produce a resolved semantic agent 560. The resolved semantic agent 560 includes an inferred intent field 510 derived from context metadata, policy-defined default objectives, or lineage inheritance, a memory field 530 initialized to record subsequent validation or mutation events, and a lineage field 570 anchoring the resolved agent to an origin signature or upstream semantic ancestor. The context block 520 and policy reference field 540 are preserved from the partial semantic agent 500 without alteration.

Fallback inference applied during scaffolding is deterministic and policy-bound. If an explicit intent field is absent, semantic purpose may be resolved under schema-defined rules from contextual role definitions, inherited lineage objectives, or policy-encoded default behaviors. If a memory field is absent, the agent is treated as a first-instance actor, and a blank trace structure is initialized within the memory field 530 upon resolution. If a lineage field is absent, the scaffolding logic assigns an origin reference derived from context metadata or environmental trust anchors to ensure traceability of subsequent evolution.

Structural scaffolding does not introduce implicit permissions or uncontrolled behavior. Where a mutation descriptor field is absent, the resolved semantic agent 560 is treated as immutable unless and until mutation authorization is explicitly granted through policies identified by the policy reference field, lineage inheritance, or subsequent structural updates. All inferred or defaulted fields generated by scaffolding are recorded within the memory field 530 as trace outcomes, preserving transparency and auditability of resolution decisions.

Partial semantic agents that cannot be resolved through structural scaffolding due to insufficient field presence, irreconcilable policy conflicts, or invalid contextual metadata are deemed structurally non-compliant. Such agents may be rejected, quarantined, or deferred for later resolution according to environmental governance rules. Resolution outcomes are deterministic and reproducible across validating nodes, enabling decentralized enforcement of schema integrity without centralized coordination.

FIG. 5 thus illustrates how partial semantic agents transition through structural scaffolding into resolved semantic agents capable of participating fully in semantic networks. By embedding fallback inference and resolution rules within the schema itself, semantic agents remain interoperable, auditable, and policy-compliant even in the presence of structural incompleteness.

### 5. Field Interaction Rules and Structural Constraints

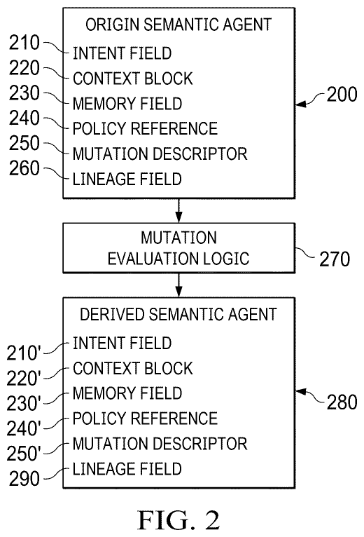

Referring now to FIG. 2, the cognition-compatible agent schema defines not only the presence of canonical semantic fields but also deterministic interaction rules and structural constraints governing how those fields may influence, restrict, or validate one another. Field interactions are enforced at the schema level to preserve semantic coherence, policy compliance, and traceable lineage across agent evolution, independent of execution environment or runtime orchestration.

As illustrated in FIG. 2, an origin semantic agent object 200 comprises an intent field 210, a context block 220, a memory field 230, a policy reference field 240, a mutation descriptor field 250, and a lineage field 260. These fields collectively define the semantic identity and governance constraints of the origin semantic agent 200. Structural constraints require that interactions among these fields remain logically coherent prior to any transformation, including alignment between the intent field 210 and applicable policies identified by the policy reference field 240, and consistency between memory field 230 entries and lineage field 260 references.

Mutation is evaluated through mutation evaluation logic 270, which operates as a schema-defined validation mechanism rather than as procedural execution logic. The mutation evaluation logic 270 examines the mutation descriptor field 250 of the origin semantic agent 200 in conjunction with the policy reference field 240 and the context block 220 to determine whether a proposed semantic transformation is authorized. Mutation evaluation further requires that the proposed transformation preserve lineage continuity and that any prior semantic commitments recorded in the memory field 230 remain auditable.

When mutation is authorized, the schema permits the creation of a derived semantic agent 280. As shown in FIG. 2, the derived semantic agent 280 may include a modified intent field 210′, an updated context block 220′, an extended memory field 230′, and a refined mutation descriptor field 250′, while retaining the policy reference field 240 from the origin semantic agent 200. The lineage field 290 of the derived semantic agent 280 references the lineage field 260 of the origin semantic agent 200, thereby extending the semantic ancestry graph without overwriting or severing prior lineage relationships.

Field interaction rules impose strict constraints on permissible transformations. Changes to the intent field are permitted only when authorized by the policy reference field and when such changes fall within the scope defined by the mutation descriptor field. Context updates must remain consistent with trust scope, role definitions, and environmental constraints encoded in the policy reference field. Memory updates recording mutation events are mandatory for all authorized transformations and must reflect both the origin semantic agent 200 and the derived semantic agent 280 to preserve traceability.

The policy reference field governs not only mutation eligibility but also propagation limits, delegation rights, and semantic scope inheritance. Discrepancies between declared policies identified by the policy reference field and memory-recorded behavior result in structural validation failure. Similarly, the mutation descriptor field restricts semantic evolution to explicitly authorized pathways. Proposed mutations outside defined descriptors are rejected or quarantined without altering lineage or memory state.

Lineage continuity is enforced by requiring that all derived semantic agents reference one or more prior semantic agents through lineage field 290. Lineage references form a directed graph that preserves provenance, trust inheritance, and semantic accountability across agent generations. Unauthorized lineage modification or deletion is structurally invalid unless explicitly permitted by governing policies.

FIG. 2 thus illustrates a policy-governed mutation pathway in which semantic evolution occurs through field-level constraints and structural validation, rather than through procedural execution control. By enforcing interaction rules among intent, context, memory, policy, mutation, and lineage fields, the cognition-compatible agent schema ensures that semantic agents evolve deterministically, auditably, and within defined governance boundaries across distributed systems.

### 6. Agent Role Definitions and Field-Based Typing

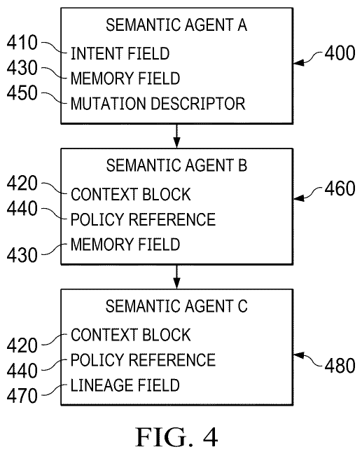

Referring now to FIG. 4, the cognition-compatible agent schema defines semantic agent roles based on the structural presence, combination, and coherence of canonical semantic fields, rather than through externally assigned identities, runtime classifications, or procedural logic. Role determination is performed through field-based typing, enabling distributed systems to interpret agent capabilities, constraints, and expectations directly from agent object structure.

As illustrated in FIG. 4, semantic agent A 400 includes an intent field 410, a memory field 430, and a mutation descriptor field 450. This combination of fields defines an agent structurally capable of proposing, recording, and evolving semantic objectives within permitted mutation scopes. The presence of the mutation descriptor field 450 in conjunction with the intent field 410 enables controlled semantic transformation, while the memory field 430 preserves traceability of such transformations. Agents exhibiting this structural configuration may be classified as mutator agents under the schema.

Semantic agent B 460, also shown in FIG. 4, includes a context block 420, a policy reference field 440, and a memory field 430, while lacking an explicit intent field or mutation descriptor. This structural configuration defines an agent oriented toward environmental evaluation, governance enforcement, and conditional activation. The memory field 430 preserves evaluation outcomes, while the policy reference field 440 constrains permissible interactions. Agents with this field composition may be classified as poller agents, capable of observing conditions, applying policy thresholds, and delegating semantic activity without independently initiating mutation.

Semantic agent C 480 comprises a context block 420, a policy reference field 440, and a lineage field 470, without an explicit memory field or mutation descriptor. This configuration supports agents that inherit semantic authority, trust scope, or governance context from upstream lineage relationships while deferring mutation and memory accumulation. Such agents may serve as delegate agents, propagating semantic context and policy constraints across distributed systems without initiating structural change.

Role definitions are not fixed or enumerated exhaustively. Instead, the schema permits additional semantic roles to emerge from other valid combinations of canonical fields, provided that structural coherence and validation thresholds are satisfied. For example, agents possessing memory and lineage fields without mutation descriptors may function as reflector agents, preserving and propagating semantic traceability without altering semantic objectives. Agents possessing context, policy, and mutation fields without memory may function as resolver agents, instantiated for short-lived or scoped semantic resolution tasks under strict governance boundaries.

Agents may transition between roles over time as canonical fields are added, removed, inferred, or modified through authorized mutation or scaffolding processes. Such role transitions are constrained by the field interaction rules described in Section 5 above and are recorded within the memory field when present, preserving auditability of semantic role evolution.

Interoperability among agents of differing roles is enabled through shared structural semantics rather than through external role registries or centralized authorities. Nodes interacting with agents evaluate field presence, policies identified by the policy reference field, and lineage anchors to determine permissible interactions, delegation eligibility, and trust scope. Role-based expectations thus emerge naturally from structural composition and validation rather than from procedural enforcement.

FIG. 4 illustrates representative interoperability relationships among agents exhibiting different field-based roles. The depicted relationships demonstrate how agents of varying structural compositions participate coherently within distributed semantic systems while preserving policy compliance, lineage continuity, and semantic integrity.

By defining agent roles through field-based typing, the cognition-compatible agent schema enables flexible, decentralized role assignment that evolves dynamically with agent structure. This approach avoids rigid role taxonomies, reduces dependency on centralized classification systems, and supports scalable semantic coordination across heterogeneous and stateless environments.

### 7. Semantic Templates and Contractual Structures

The cognition-compatible agent schema further supports the use of semantic templates and contractual structures to standardize instantiation, validation, and controlled evolution of semantic agent objects across distributed systems. Semantic templates and contractual structures operate at the schema layer to define expected field compositions, validation thresholds, fallback behaviors, and mutation permissions without prescribing procedural execution logic or centralized orchestration.

A semantic template defines a canonical structural configuration for a class of semantic agent objects by specifying required canonical fields, optional canonical fields, and permissible field combinations. Templates may further define acceptable value formats, reference constraints, or coherence requirements for individual fields. For example, a persistent agent template may require the presence of an intent field, a memory field, a policy reference field, and a lineage field, while treating mutation descriptors as optional or conditionally enabled. A delegation-oriented template may prioritize context blocks and policies identified by the policy reference field while allowing intent and memory fields to be inferred or scaffolded.

Semantic templates are not executable programs or workflows. Instead, templates function as structural schemas against which agent objects are validated. During validation, a semantic agent object is evaluated for compliance with one or more templates based on field presence, field coherence, and applicable fallback inference rules. An agent object may satisfy multiple templates simultaneously or transition between templates as its field composition evolves through authorized mutation or scaffolding processes.

Contractual structures extend semantic templates by defining structural constraints and resolution rules governing how agents instantiated under a given template may participate in validation, mutation, delegation, or interoperability. A contractual structure may specify, for example, that an agent missing an explicit intent field must defer semantic action until intent is resolved through lineage inheritance or contextual inference, or that mutation events under a given template must be recorded as trace outcomes within the memory field prior to lineage extension.

Contracts further define permissible fallback behaviors for partial semantic agents. Where an agent object fails to meet all required template fields, contractual structures specify whether scaffolding, delegation, or rejection is appropriate, and under what policy constraints such resolution may occur. These constraints ensure that structural incompleteness does not result in uncontrolled behavior or silent semantic drift.

Semantic templates and contractual structures may be referenced within the policy reference field of a semantic agent object, embedded within environmental governance frameworks, or distributed through decentralized schema registries. Nodes evaluating agents retrieve applicable template and contract definitions to perform validation, determine fallback resolution strategies, and enforce mutation eligibility without requiring per-agent custom logic or centralized control systems.

Templates enable consistent agent instantiation across distributed environments by providing predefined structural expectations at creation time. Contractual structures ensure that agents instantiated under a given template retain semantic coherence and policy compliance throughout their lifecycle, even as canonical fields are inferred, modified, or partially degraded during distributed operation.

FIG. 3 and FIG. 5 support the application of semantic templates and contractual structures by illustrating how partial semantic agents remain structurally valid under fallback inference and scaffolding resolution. These figures demonstrate how template-driven validation and contract-governed resolution preserve semantic continuity and auditability despite incomplete field composition.

By embedding semantic templates and contractual structures within the cognition-compatible agent schema, scalable, decentralized semantic networks are enabled in which agent instantiation, evolution, and interoperability are governed by structural integrity and embedded policy, rather than by external orchestration logic or runtime enforcement mechanisms.

### 8. Interoperability Between Full and Partial Semantic Agents

The cognition-compatible agent schema ensures that full semantic agents and partial semantic agents interoperate coherently across distributed systems without requiring centralized synchronization, shared execution state, or external role registries. Interoperability is achieved through structural validation, field-aware resolution, and lineage continuity embedded directly within the semantic agent object model.

Referring again to FIG. 4, agents of differing structural completeness participate in shared semantic workflows by exposing canonical fields that permit deterministic interpretation of intent, policy scope, mutation eligibility, and trust inheritance. Full semantic agents, comprising all six canonical fields, function as structurally complete anchors within semantic networks. Partial semantic agents, comprising subsets of canonical fields, remain interoperable by deferring missing semantic responsibilities through delegation, fallback inference, or structural scaffolding as permitted under applicable validation contracts.

When a partial semantic agent interacts with a full semantic agent, the interaction is evaluated based on field coherence rather than role identity or execution context. For example, a partial agent lacking an explicit intent field may inherit semantic direction from a full agent through lineage references or context-based delegation, while preserving its own policy constraints and contextual scope. Conversely, a full agent delegating semantic tasks to a partial agent evaluates whether the receiving agent's available fields satisfy minimum validation thresholds and whether fallback resolution is permitted under governing policies.

Interoperability is further governed by trust-scoped inheritance, wherein semantic goals, policy constraints, or lineage references may propagate between agents only when structural coherence and contractual permissions allow such inheritance. Agents do not assume authority or semantic responsibility implicitly; rather, authority propagation is evaluated through explicit field presence, policies identified by the policy reference field, and lineage anchoring embedded within the agent objects themselves.

Where a partial agent's incompleteness exceeds validation thresholds during interaction, structural scaffolding mechanisms may be invoked to infer or reconstruct missing fields prior to participation. Such scaffolding may be performed locally by a validating node, by a peer agent, or by a federated resolution service, provided that all inferred fields and resolution outcomes are recorded transparently within the agent's memory and lineage fields. Agents that cannot be scaffolded deterministically are excluded from interaction until structural compliance is restored.

Interoperability does not require uniform infrastructure or synchronized validators. Nodes interacting with agents parse canonical fields, verify schema compliance, and enforce policy constraints independently based on the structural information carried by each agent object. As a result, agents may collaborate across heterogeneous systems, trust domains, and execution environments while preserving semantic integrity and auditability.

FIG. 4 illustrates representative interoperability relationships among agents exhibiting differing structural compositions, demonstrating how delegation, inheritance, and collaboration occur through shared schema semantics rather than procedural coordination. These relationships support distributed reasoning chains in which semantic continuity is preserved even as agents vary in completeness, authority, or lifecycle stage.

By formalizing interoperability at the schema level, scalable semantic networks in which cognition-compatible agents cooperate flexibly across decentralized systems are enabled. Structural interoperability ensures that semantic execution remains consistent, auditable, and policy-compliant regardless of agent completeness, deployment environment, or transport medium.

### 9. Serialization and Stateless Compatibility

The cognition-compatible agent schema defines serialization mechanisms that enable semantic agent objects to be transmitted, reconstructed, validated, and operated upon across distributed computing environments, including stateless, ephemeral, or resource-constrained systems. Serialization preserves the internal structural coherence of the semantic agent object, ensuring that canonical semantic fields remain machine-readable, verifiable, and interoperable independent of the environment in which the agent is instantiated or executed.

Each semantic agent object is serialized as a structured data representation in which the canonical semantic fields—intent, context, memory, policy, mutation, and lineage—are individually addressable and independently parseable. Serialization preserves field boundaries, reference relationships, and validation metadata such that receiving nodes may reconstruct the semantic agent object without reliance on external session state, centralized registries, or synchronized execution contexts. Serialized representations may be encoded using extensible object formats capable of hierarchical field representation and integrity verification.

Upon receipt of a serialized semantic agent object, a validating node evaluates the structural presence and coherence of canonical fields in accordance with the schema-defined validation rules described in preceding sections. Where one or more fields are absent or degraded, fallback inference or structural scaffolding mechanisms may be applied prior to participation, delegation, or mutation. Validation outcomes are determined solely from the serialized object contents and applicable policies identified by the policy reference field, enabling deterministic interpretation across heterogeneous systems.

Stateless compatibility is achieved by embedding sufficient semantic metadata within the context block, policy reference field, memory field, and lineage field of the serialized agent object to permit independent operation. Nodes receiving serialized agents are not required to maintain prior knowledge of the agent's execution history, instantiation environment, or transport pathway. Semantic continuity is preserved through embedded trace outcomes and lineage references rather than through persistent session bindings.

The memory field of a serialized semantic agent object retains trace outcomes corresponding to prior validation events, mutation authorizations, scaffolding resolutions, or delegation actions. These trace outcomes may be cryptographically bound to field contents or lineage anchors to support integrity verification and provenance reconstruction. As a result, serialized agents enable semantic replay, auditability, and recovery following network disruption, node failure, or asynchronous propagation.

Lineage references embedded within serialized agents allow distributed systems to reconstruct semantic ancestry graphs post hoc without centralized coordination. Nodes may evaluate lineage continuity, trust inheritance, or mutation provenance using lineage field data alone, enabling decentralized enforcement of governance and validation rules across stateless transport layers.

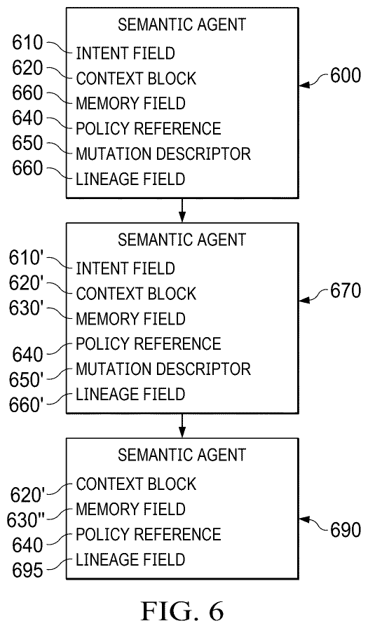

FIG. 1 supports Section 9 by illustrating the internal field structure preserved during serialization, while FIG. 6 illustrates reconstruction of traceable lineage across multiple serialized agents propagated through distributed environments. These figures collectively demonstrate how serialization preserves semantic identity, governance constraints, and auditability independent of execution context.

By enabling serialization and stateless compatibility at the semantic agent object level, resilient, scalable cognition-compatible systems capable of operating across cloud infrastructures, edge devices, federated networks, intermittently connected environments, and asynchronous message-passing architectures are supported without dependency on synchronized memory architectures or centralized execution controllers.

### 10. Field-Aware Structural Scaffolding and Default Resolution

The cognition-compatible agent schema incorporates field-aware structural scaffolding and default resolution mechanisms that enable semantic agent objects with incomplete or degraded structural configurations to operate coherently within distributed cognitive systems. Structural scaffolding is applied when a semantic agent object does not satisfy minimum validation thresholds due to missing, corrupted, or unresolved canonical fields, and operates deterministically under schema-defined rules rather than through procedural execution logic.

Referring again to FIG. 5, structural scaffolding is initiated when a semantic agent object fails validation based on field presence or field coherence. The scaffolding mechanism evaluates the canonical fields present in the agent object and determines whether missing semantic components may be resolved under schema-defined rules, reconstructed, or defaulted in accordance with applicable policies identified by the policy reference field, contextual metadata, lineage anchors, and environmental governance constraints. Structural scaffolding is applied only when permitted by schema rules and does not introduce semantic authority beyond that implied by existing fields.

When an intent field is absent, semantic purpose may be resolved under schema-defined rules from lineage references, contextual role definitions, or policy-encoded default objectives associated with the agent's trust domain. Inferred intent is bounded by policy constraints and lineage scope and is recorded explicitly within the resolved agent object to preserve transparency and auditability. Where no permissible inference path exists, the agent object is restricted from initiating semantic action until intent resolution occurs.

When a memory field is absent or uninitialized, the scaffolding mechanism initializes a memory structure capable of recording subsequent validation outcomes, mutation authorizations, and delegation events. The initialized memory field does not fabricate historical trace outcomes and is explicitly marked as scaffolded to distinguish inferred state from inherited or prior semantic history.

When a policy reference field is missing, default governance rules scoped by the agent's context block and environmental domain are applied. Such default policies constrain mutation eligibility, semantic propagation, and delegation authority until explicit policies identified by the policy reference field are restored or updated through authorized mutation or environmental discovery. Default policy application is recorded within the agent's memory field as a trace outcome.

When a mutation descriptor field is absent, the semantic agent object is treated as structurally immutable. In this state, the agent is prohibited from altering intent, role classification, or structural composition until mutation authorization is explicitly granted through policies identified by the policy reference field, lineage inheritance, or subsequent scaffolded updates. This immutability constraint prevents uncontrolled semantic drift in partially instantiated agents.

Structural scaffolding is transparent and traceable. All inferred fields, default resolutions, and scaffolding interventions are recorded as trace outcomes within the memory field of the resolved agent object, and associated with lineage anchors where applicable. This ensures that downstream agents, validating nodes, and auditors may distinguish original agent state from scaffolded state and evaluate semantic evolution deterministically.

Structural scaffolding does not guarantee resolution. Semantic agent objects that lack sufficient canonical fields to permit deterministic inference, or that present irreconcilable conflicts among context, policy, and lineage constraints, are deemed structurally non-compliant. Such agents may be rejected, quarantined, or deferred for later resolution according to environmental governance rules. No semantic authority, mutation permission, or lineage continuity is assumed for unresolved agents.

Structural scaffolding resolves structural completeness and semantic admissibility only, and does not initiate, schedule, or perform execution of semantic actions. Through field-aware structural scaffolding and deterministic default resolution, cognition-compatible semantic agents remain operational, auditable, and semantically coherent even in degraded, disconnected, or minimally initialized environments. These mechanisms enable resilient semantic execution across distributed systems while preserving strict governance, validation integrity, and traceable semantic evolution.

### 11. Schema Governance, Integrity, and Field Provenance

The cognition-compatible agent schema incorporates structural mechanisms for enforcing governance, integrity, and provenance of semantic agent objects as they evolve across distributed systems. Governance is enforced at the data-object level through field coherence requirements, policy-referenced constraints, and lineage anchoring, enabling semantic networks to maintain consistency without centralized enforcement layers or external trust registries.

Schema integrity is maintained by binding the canonical semantic fields of a semantic agent object to its structural identity. Each canonical field, including the intent field, context block, memory field, policy reference field, mutation descriptor field, and lineage field, is subject to integrity verification to ensure that field contents remain consistent with schema-defined interaction rules and authorized mutation pathways. Structural validation detects unauthorized field modification, invalid field combinations, or incoherent field relationships and designates affected agent objects as non-compliant.

Mutation events, scaffolding resolutions, delegation actions, and validation outcomes are recorded as trace outcomes within the memory field of the semantic agent object. These trace outcomes reference the applicable policy constraints and lineage anchors in effect at the time of the event, forming a verifiable record of semantic evolution. Recording such events within the agent object itself preserves auditability across serialization, transfer, and rehydration events without reliance on external logs or centralized monitoring systems.

Field provenance enforcement is further illustrated with respect to FIG. 6, as described below. Lineage references form a directed semantic graph that records the ancestry of semantic identity, mutation authorization, and governance context. This lineage graph enables downstream nodes to verify that agent behavior and evolution complied with applicable schema rules and policy constraints at each stage of propagation.

In some embodiments, integrity verification may be supported by cryptographic techniques that bind field contents, trace outcomes, or lineage references to verifiable signatures or hashes. Such techniques ensure that field provenance and mutation history are tamper-evident and that unauthorized modifications are detectable during structural validation. The use of cryptographic binding is optional and does not alter the schema-level validation model, which remains independent of any specific cryptographic implementation.

Updates to schema definitions, including the introduction of revised field constraints, additional semantic templates, or modified fallback inference rules, are governed through versioned policies identified by the policy reference field. Semantic agent objects instantiated under earlier schema versions may interoperate with agents instantiated under later versions, provided that field coherence, lineage continuity, and policy resolution remain valid under the governing contracts.

By embedding governance, integrity enforcement, and provenance tracking within the semantic agent object itself, decentralized systems are able to reason deterministically about semantic validity, mutation authorization, and trust inheritance. This approach eliminates dependence on centralized validation authorities and supports scalable, auditable semantic execution across heterogeneous and stateless environments.

### 12. Traceable Semantic Lineage and Provenance Enforcement

Referring now to FIG. 6, the cognition-compatible agent schema supports construction and verification of a traceable semantic lineage graph that records semantic ancestry, mutation authorization, and governance continuity across successive generations of semantic agent objects. Lineage tracking is performed at the data-object level and does not rely on centralized identity registries, external audit logs, or synchronized execution state.

As illustrated in FIG. 6, a semantic agent 600 comprises an intent field 610, a context block 620, a memory field 630, a policy reference field 640, a mutation descriptor field 650, and a lineage field 660. The lineage field 660 of semantic agent 600 identifies the agent as an origin or prior semantic ancestor within a lineage graph. The memory field 630 records trace outcomes corresponding to validation, instantiation, or authorized mutation events associated with semantic agent 600.

Semantic agent 670 is derived from semantic agent 600 through a schema-authorized mutation or transformation. Semantic agent 670 includes a modified intent field 610′, an updated context block 620′, an extended memory field 630′, and a refined mutation descriptor field 650′, while retaining the policy reference field 640. The lineage field 680 of semantic agent 670 references the lineage field 660 of semantic agent 600, thereby extending the lineage graph and preserving semantic ancestry without overwriting prior lineage information.

The memory field 630′ of semantic agent 670 records trace outcomes associated with the derivation event, including validation of mutation authorization under the policy reference field 640 and compliance with constraints defined by the mutation descriptor field 650. These trace outcomes preserve an auditable record of semantic evolution embedded directly within the agent object.

Semantic agent 690 represents a further derivative or delegated agent generated downstream from semantic agent 670. In the embodiment shown, semantic agent 690 includes a context block 620′, a memory field 630″, a policy reference field 640, and a lineage field 695, while lacking an explicit intent field or mutation descriptor. This configuration illustrates that lineage continuity does not require full field inheritance and that partial semantic agents may remain provenance-valid within the lineage graph.

The lineage field 695 of semantic agent 690 references the lineage field 680 of semantic agent 670, thereby forming a directed semantic ancestry chain spanning semantic agents 600, 670, and 690. Each lineage reference preserves trust inheritance, policy continuity, and mutation provenance across agent generations. At no point is lineage rewritten, collapsed, or implicitly inferred; all lineage relationships are explicitly recorded within the agent objects themselves.

Lineage validation is performed structurally by evaluating the lineage field in conjunction with memory trace outcomes and policies identified by the policy reference field. Nodes interacting with a semantic agent object may verify that each derivation step in the lineage graph was authorized under applicable policy constraints and mutation descriptors, and that no unauthorized semantic authority was introduced during agent evolution.

Arrows depicted in FIG. 6 represent semantic derivation relationships between agent objects and do not indicate execution order, runtime control flow, or temporal dependency. Lineage relationships are declarative and structural, enabling post hoc audit, distributed verification, and deterministic reconstruction of semantic evolution independent of execution context.

FIG. 6 thus illustrates how the cognition-compatible agent schema preserves traceable semantic lineage across full and partial semantic agents. By embedding lineage references and trace outcomes directly within agent objects, decentralized systems enforce provenance, governance, and trust inheritance without reliance on centralized authorities, external logging systems, or procedural enforcement mechanisms.

### 13. Use in Distributed Cognitive Systems and Semantic Networks

The cognition-compatible agent schema disclosed herein is applicable to a wide range of distributed cognitive systems and semantic networks in which autonomous or semi-autonomous agents must operate persistently, cooperatively, and under governance constraints across heterogeneous computing environments. By embedding semantic identity, memory continuity, mutation eligibility, policy enforcement, and lineage traceability directly within the agent object, the schema enables decentralized coordination without reliance on centralized execution control, shared session state, or monolithic orchestration layers.

In distributed cognitive systems, semantic agent objects instantiated under the schema propagate across trust-scoped domains while retaining their structural integrity and governance constraints. Nodes receiving such agents evaluate canonical fields locally to determine semantic validity, mutation eligibility, delegation authority, and trust scope. Semantic progression, task refinement, and delegation decisions are recorded within the agent's memory and lineage fields, allowing reasoning continuity to persist as agents traverse execution environments, administrative boundaries, or network partitions.

Semantic networks constructed using the disclosed schema support interoperability among agents of differing structural completeness through schema-based validation, fallback inference, and structural scaffolding. Partial semantic agents participate in reasoning chains, delegation workflows, or governance evaluation without requiring full instantiation of all canonical fields, provided that minimum validation thresholds are satisfied. This enables stateless nodes, edge devices, asynchronous messaging systems, and federated infrastructures to participate in semantic execution without maintaining persistent agent runtimes.

In such environments, semantic agents negotiate role allocation, policy enforcement, and semantic evolution through field-aware validation rather than procedural messaging or externally imposed workflows. Governance decisions, trust inheritance, and mutation constraints are enforced through embedded policies identified by the policy reference field and lineage anchors, allowing semantic authority to propagate only where structurally permitted. Semantic integrity is preserved even when agents are serialized, paused, transferred, or reconstructed across execution boundaries.

Representative applications of the schema include collaborative multi-agent reasoning systems, decentralized knowledge graph evolution, distributed task delegation frameworks, semantic governance overlays, and cognition-native coordination layers for artificial intelligence systems. In each case, agent behavior and evolution are governed by structural contracts embedded within the agent object rather than by runtime control logic specific to any particular execution platform.

By anchoring distributed cognitive systems to the disclosed agent schema, a scalable, resilient foundation for semantic coordination, persistent reasoning, and policy-compliant agent evolution is provided across heterogeneous and decentralized computing environments.

### 14. Conclusion

The cognition-compatible agent schema disclosed herein defines a structural model for semantic agent objects that are memory-bearing, policy-governed, and traceably evolvable across distributed computing environments. By formalizing canonical semantic fields, schema-based validation rules, fallback inference mechanisms, structural scaffolding logic, and lineage-based provenance tracking, the present disclosure provides a complete and enabling framework for cognition-native semantic execution independent of runtime orchestration, transport protocol, or execution substrate.

The embodiments described throughout this specification demonstrate that semantic agents structured in accordance with the disclosed schema may be instantiated, validated, propagated, mutated, serialized, and rehydrated across heterogeneous systems while preserving semantic continuity, governance constraints, and auditability. Full semantic agents and partial semantic agents are both supported under deterministic structural rules, enabling resilient operation in stateless, asynchronous, federated, or resource-constrained environments.

Implementation can occur without requiring any specific programming language, execution engine, messaging protocol, cryptographic primitive, or centralized authority. The techniques can be accomplished at the data-object and schema level, such that semantic behavior, mutation eligibility, and governance enforcement arise from structural validation of the agent object itself. This abstraction ensures broad applicability and avoids a need for coupling to any particular software architecture or technological implementation.

The modularity of the disclosed schema further enables extensions that may include dynamic schema evolution mechanisms, distributed template registries, agent federation and identity resolution systems, trust graph construction, semantic governance overlays, biologically anchored agents, cognition-aware policy enforcement, or large-language-model-driven mutation and agent modification systems.

The disclosed schema further enables separation of semantic authority from execution logic in emerging autonomous and self-modifying systems.

By separating semantic identity, governance, memory, and evolution from execution-layer behavior, a durable and extensible foundation is provided for future cognition-native computing systems.

### 15. Definitions

As used herein, the term “agent,” “semantic agent,” “agent object,” or “semantic agent object” refers to a memory-bearing data object structured in accordance with the cognition-compatible schema disclosed in this specification. An agent is defined by the presence of one or more canonical semantic fields that collectively encode semantic intent, governance constraints, mutation eligibility, and traceable lineage. An agent is distinguished from a runtime process, execution thread, or session construct, and exists independently of any particular execution environment.

As used herein, the term “intent field” refers to a semantic component of an agent object that expresses a goal, objective, purpose, or semantic direction associated with the agent. The intent field provides a declarative anchor for evaluating permissible behavior, policy alignment, and mutation eligibility without encoding procedural steps, control logic, or execution instructions.

As used herein, the term “context block” or “context field” refers to a structured collection of metadata associated with an agent object that informs interpretation of intent, policy applicability, trust scope, and environmental conditions. Context metadata may include, without limitation, origin identifiers, deployment attributes, trust domains, role indicators, or environmental parameters relevant to localized semantic evaluation.

As used herein, the term “memory field” refers to a canonical semantic field embedded within an agent object that records trace outcomes corresponding to validation events, mutation authorizations, delegation actions, scaffolding resolutions, or other semantic evolution events. The memory field preserves reasoning continuity, auditability, and semantic history across serialization, transfer, and rehydration of the agent object.

As used herein, the term “policy reference field” refers to a structural linkage within an agent object that identifies one or more governing policies applicable to the agent. Policies identified by the policy reference field define constraints on permissible mutation, delegation authority, propagation scope, trust thresholds, or semantic behavior. Policies identified by the policy reference field may resolve to internal policy objects, external identifiers, or decentralized policy aliasing mechanisms, provided such references are verifiable during validation.

As used herein, the term “mutation descriptor field” or “mutation field” refers to a semantic component that defines authorized transformation pathways for an agent object. Mutation descriptors specify conditions, triggers, constraints, or bounds under which the agent's intent, role, or structural composition may evolve. Mutation descriptors operate in conjunction with policies identified by the policy reference field, context metadata, and lineage constraints to ensure controlled semantic evolution.

The term “lineage field” refers to a canonical semantic field that references one or more semantic ancestors of an agent object. The lineage field forms part of a directed semantic graph that preserves provenance, trust inheritance, policy continuity, and mutation history across agent generations. Lineage references enable deterministic reconstruction of semantic evolution without reliance on centralized registries.

As used herein, the term “partial agent,” “partial semantic agent,” “partial agent object,” or “partial semantic agent object” refers to a semantic agent object that contains fewer than all canonical semantic fields but remains structurally valid under the cognition-compatible schema. A partial agent may participate in validation, delegation, or interoperability through fallback inference, structural scaffolding, or lineage-based resolution as disclosed herein.

As used herein, the term “structural scaffolding” refers to a deterministic, schema-defined resolution process by which missing or degraded canonical fields in a partial agent are inferred, reconstructed, or defaulted using available context metadata, policies identified by the policy reference field, lineage anchors, or environmental constraints. Structural scaffolding does not introduce semantic authority beyond that implied by existing fields and records all resolutions as trace outcomes.

As used herein, the term “fallback inference” refers to rule-bound, schema-defined resolution logic applied when one or more canonical semantic fields are absent from a semantic agent object. Fallback inference operates exclusively under constraints imposed by available canonical semantic fields, policies identified by the policy reference field, and lineage anchors, and does not include probabilistic reasoning, learned model inference, or heuristic approximation unless explicitly authorized by governing policy.

As used herein, the term “semantic template” refers to a predefined canonical field arrangement that defines a class or role of agent objects. Semantic templates specify required and optional fields, coherence rules, and validation thresholds for standardized agent instantiation and evolution.

As used herein, the term “contractual structure” refers to schema-level constraints associated with a semantic template that govern validation outcomes, fallback behavior, mutation eligibility, and delegation authority. Contractual structures enforce governance without prescribing procedural execution logic.

As used herein, the term “trace outcome” refers to a recorded semantic event stored within an agent's memory field, including validation decisions, mutation events, scaffolding resolutions, or delegation actions. Trace outcomes preserve a verifiable history of semantic evolution.

As used herein, the term “serialization” refers to the encoding of a semantic agent object into a structured, portable representation suitable for transmission, storage, and reconstruction across distributed or stateless environments, while preserving canonical field boundaries and validation metadata.

As used herein, the term “stateless compatibility” refers to the ability of a serialized agent object to be validated, interpreted, and evolved without reliance on external session memory, synchronized execution state, or centralized coordination.

As used herein, the term “schema governance” refers to decentralized enforcement of semantic integrity, mutation constraints, and lineage continuity through structural validation of agent objects rather than through centralized authorities.

As used herein, the term “field provenance” refers to the ability to trace the origin, mutation history, and validation context of each canonical semantic field within an agent object through lineage references, memory traces, and optional cryptographic binding.

As used herein, the term “deterministic” refers to schema-deterministic behavior in which identical semantic agent object structures, evaluated under identical policy references and contextual parameters, yield identical validation, mutation-eligibility, and structural scaffolding outcomes. Schema-deterministic behavior is independent of execution environment, runtime scheduling, transport medium, or procedural execution order.

As used herein, the term “structural validation” refers to validation performed on a semantic agent object prior to any semantic execution, mutation, delegation, or propagation, based solely on internal structure, field presence, and field coherence of the semantic agent object, without reliance on procedural execution results or external session state.

As used herein, the term “policy” refers to a machine-resolvable governance artifact referenced by the policy reference field that declaratively defines constraints on permissible mutation, delegation, propagation, or semantic scope of a semantic agent object. Policy evaluation is structural and declarative and is not dependent on execution history external to the semantic agent object.

As used herein, the term “cognition-native” refers to a computing paradigm in which semantic reasoning, memory continuity, governance constraints, identity, and evolutionary state are represented as primary architectural substrates of a computing system, rather than as emergent or incidental properties of procedural execution, application logic, or runtime control flow. In a cognition-native system, cognitive state persists across execution environments, transport layers, and time through structurally defined representations that may be validated, governed, and evolved independently of any particular process, session, or execution engine.

As used herein, the term “cognition-compatible” refers to structural compliance with, or interoperability relative to, a cognition-native computing paradigm. A cognition-compatible system, component, or data object is not itself required to instantiate a full cognition-native execution environment, but is structured such that it may participate in, interoperate with, or be validated by cognition-native systems. In particular, a cognition-compatible semantic agent object maintains structural properties that enable persistence, validation, governance, and semantic continuity regardless of whether it is deployed within a cognition-native platform or within a non-cognition-native computing environment.

As used herein, references to ‘cognitive systems,’ ‘distributed cognitive systems,’ or ‘cognitive infrastructures’ refer to systems that implement or interoperate with cognition-native or cognition-compatible components, and do not require full cognition-native execution.

As used herein, “semantic execution” refers solely to the interpretation or consideration of a semantic agent object following structural validation, and does not encompass runtime scheduling, procedural control flow, or execution lifestyle management.

As used herein, “structurally coherent,” with respect to a semantic agent object, means that the semantic agent object includes one or more canonical semantic fields and satisfies schema-defined structural rules that render the semantic agent object admissible as a valid agent representation based solely on information embedded within the semantic agent object, without reliance on external state, execution context, or semantic interpretation.

As used herein, “structurally compatible,” with respect to two or more canonical semantic fields within a semantic agent object, means that the canonical semantic fields are permitted to coexist within the same semantic agent object under schema-defined structural rules, including satisfaction of required cross-field dependencies and reference constraints, as determined without interpreting semantic meaning, execution outcomes, or runtime behavior.

What is claimed is:

1. A cognition-compatible semantic agent object system, comprising:
a semantic agent object stored in a non-transitory computer-readable medium, the semantic agent object comprising one or more embedded canonical semantic fields selected from the group consisting of an intent field, a context block, a memory field, a policy reference field, a mutation descriptor field, and a lineage field; and
a node configured to interact with the semantic agent object and including a set of instructions that when executed determine whether the semantic agent object is structurally coherent based on presence of the one or more canonical semantic fields and whether the one or more canonical semantic fields, to the extent present, are structurally compatible based on a set of rules that determine whether those fields are permitted to coexist,
wherein whether the semantic agent object is structurally coherent and whether the one or more canonical semantic fields are structurally compatible are determined based only on information embedded within the semantic agent object.

2. The system of claim 1, wherein the semantic agent object is a partial semantic agent comprising fewer than all of the group of canonical semantic fields and wherein the partial semantic agent is determined to be structurally valid under schema-defined validation rules.

3. The system of claim 2, wherein the partial semantic agent comprises at least two canonical semantic fields.

4. The system of claim 1, wherein the intent field encodes a declarative semantic objective without specifying procedural execution steps.

5. The system of claim 1, wherein the policy reference field identifies one or more governing policies constraining permissible mutation, delegation, or semantic scope of the semantic agent object.

6. The system of claim 1, wherein the mutation descriptor field defines authorized transformation pathways for modifying one or more canonical semantic fields.

7. The system of claim 1, wherein the memory field is configured to record trace outcomes corresponding to validation events, mutation authorizations, scaffolding resolutions, or delegation actions.

8. The system of claim 1, wherein the lineage field references one or more prior semantic agent objects, forming a directed semantic ancestry graph.

9. The system of claim 1, wherein determining whether the semantic agent object is structurally coherent does not rely on external session state, centralized registries, or synchronized execution context.

10. The system of claim 2, further comprising a structural scaffolding mechanism configured to infer, reconstruct, or default missing canonical semantic fields in accordance with policies identified by the policy reference field, context metadata, or lineage anchors.

11. The system of claim 10, wherein inferred or defaulted canonical semantic fields are recorded as trace outcomes in the memory field.

12. The system of claim 1, wherein the semantic agent object is serializable and reconstructable across stateless or distributed computing environments while preserving structural coherence.

13. The system of claim 1, wherein semantic roles of the semantic agent object are determined based on structural combinations of the one or more canonical semantic fields used to determine whether the semantic agent object is structurally coherent and not externally assigned identifiers.

14. The system of claim 1, wherein whether the semantic agent object is structurally coherent is determined prior to any semantic execution, mutation, delegation, or propagation, such that eligibility for semantic participation is determined as a function of structural coherence of the semantic agent object rather than as a result of runtime execution.

15. The system of claim 14, wherein semantic participation by the semantic agent object is prohibited unless the semantic agent object satisfies schema-defined structural validation rules.

16. The system of claim 8, wherein references in the lineage field are sufficient to verify, under schema-defined rules, provenance, trust inheritance, and mutation authorization across successive semantic agent objects.

17. The system of claim 1, further including mutation constraints for the semantic agent object based on whether proposed transformations fall outside mutation limitations defined by the mutation descriptor field and the policy reference field.

18. A non-transitory computer-readable medium storing instructions that, when executed by one or more processors, cause the processors to implement the system of claim 1.

19. A computer implanted method for validating cognition-compatible semantic agent objects, the method comprising:
determining whether a semantic agent object is structurally valid based on presence and coherence of a plurality of canonical semantic fields embedded within the semantic agent object, the canonical semantic fields including a policy reference field, a memory field, and a mutation descriptor field;
determining mutation eligibility of the semantic agent object using the policy reference field and the mutation descriptor field; and
recording validation or mutation outcomes within the memory field,
wherein determining whether the semantic agent object is structurally valid, determining mutation eligibility, and recording validation is performed without prescribing execution order, scheduling, or runtime control.

20. The method of claim 19, further comprising resolving, when the semantic agent object is a partial semantic agent that does not include one or more of the plurality of canonical semantic fields by inferring missing canonical semantic fields using structural scaffolding.

21. The method of claim 19, further including preserving semantic continuity through lineage references embedded within the semantic agent object.

22. The method of claim 19, further including serializing, transmitting, and reconstructing the semantic agent object across stateless computing environments.

23. The method of claim 19, wherein determining whether the semantic agent object is structurally valid includes applying a set of schema-defined structural rules that confirm the presence of one or more of the plurality of canonical semantic fields and determining whether the canonical semantic fields, if present, are internally consistent and admissible under the schema-defined structural rules.

24. The method of claim 23, wherein applying the set of schema-defined structural rules includes determining whether mutation descriptors reference an applicable policy field, lineage references resolve to a prior state, and memory entries are compatible with mutation scope.

25. The method of claim 24, wherein determining whether mutation descriptors reference an applicable policy field, lineage references resolve to a prior state, and memory entries are compatible with mutation scope is completed without interpreting semantic correctness or execution results.

26. The method of claim 19, further including enforcing governance of semantic evolution at the data-object level through structural validation.
